(19) United States
(12) Patent Application Publication
(10) Pub. No.: US 2013/0303748 A1
(43) Pub. Date: Nov. 14, 2013

(54) METHOD FOR MAKING ALDEHYDE-FUNCTIONALIZED POLYSACCHARIDES

(71) Applicants: Samuel D. Arthur, Wilmington, DE (US); Steven W. Shuey, Chadds Ford, PA (US); Barry M. Trost, Los Altos Hills, CA (US)

(72) Inventors: Samuel D. Arthur, Wilmington, DE (US); Steven W. Shuey, Chadds Ford, PA (US); Barry M. Trost, Los Altos Hills, CA (US)

(73) Assignee: Actamax Surgical Materials, LLC, Berkeley, CA (US)

(21) Appl. No.: 13/468,176

(22) Filed: May 10, 2012

(51) Int. Cl. C08B 37/00; C08B 31/00; C08B 15/00; C08B 37/18; C08B 11/12; C08B 37/08; C08B 37/12; C08B 37/02; C08B 11/08

(52) U.S. Cl. 536/53; 536/123.1; 536/112; 536/104; 536/56; 536/96; 536/98

(57) ABSTRACT

A method for making aldehyde-functionalized polysaccharides having pendant aldehyde groups is described. The method involves the hydroformylation of an alkene-functionalized polysaccharide. The resulting aldehyde-functionalized polysaccharides are useful for forming hydrogel tissue adhesives and sealants for medical applications.

### FIELD OF THE INVENTION

The invention relates to the field of medical adhesives and sealants. More specifically, the invention relates to a novel method for making aldehyde-functionalized polysaccharides containing pendant aldehyde groups that are useful for forming hydrogel tissue adhesives and sealants for medical applications.

### BACKGROUND OF THE INVENTION

Tissue adhesives and sealants have many potential medical applications, including wound closure, supplementing or replacing sutures or staples in internal surgical procedures, preventing leakage of fluids such as blood, bile, gastrointestinal fluid and cerebrospinal fluid, adhesion of synthetic onlays or inlays to the cornea, drug delivery devices, and as anti-adhesion barriers to prevent post-surgical adhesions. Conventional tissue adhesives are generally not suitable for a wide range of adhesive applications. For example, cyanoacrylate-based adhesives have been used for topical wound closure, but the release of toxic degradation products limits their use for internal applications. Fibrin-based adhesives are slow curing, have poor mechanical strength, and pose a risk of viral infection. Additionally, fibrin-based adhesives do not bond covalently to the underlying tissue.

Several types of hydrogel tissue adhesives have been developed, which have improved adhesive and cohesive properties and are nontoxic. These hydrogels are generally formed by reacting a component having nucleophilic groups with a component having electrophilic groups to form a crosslinked network via covalent bonding. A number of these hydrogel tissue adhesives are prepared using an oxidized polysaccharide containing aldehyde groups as one of the reactive components (see for example, Kodokian et al., copending and commonly owned U.S. Patent Application Publication No. 2006/0078536 A1, Goldmann, U.S. Patent Application Publication No. 2005/0002893 A1, and Nakajima et al., U.S. Patent Application Publication No. 2008/0319101 A1). However, the instability of oxidized polysaccharides in aqueous solution may limit their shelf-life for commercial use.

Lu et al. (U.S. Patent Application Publication No: 2012/0004194 A1) describes aldehyde-functionalized polysaccharides containing pendant aldehyde groups that are more stable in aqueous solution than oxidized polysaccharides. The use of these aldehyde-functionalized polysaccharides to form hydrogel tissue adhesives is described by Lu et al. (WO 2011/002888). However, methods known in the art to prepare the aldehyde-functionalized polysaccharides containing pendant aldehyde groups are complicated and tedious.

Therefore, the need exists for a simpler, more straightforward method for preparing aldehyde-functionalized polysaccharides containing pendant aldehyde groups, which can be used to form hydrogel tissue adhesives and sealants for medical applications.

### SUMMARY OF THE INVENTION

One embodiment provides a method for making an aldehyde-functionalized polysaccharide having pendant aldehyde groups, said method comprising the steps of:
a) reacting in a solvent, an alkene-functionalized polysaccharide with a mixture of carbon monoxide and hydrogen, said mixture having a ratio of carbon monoxide to hydrogen of about 4:1 to about 1:4 by volume, in the presence of a metal hydroformylation catalyst at a temperature of about 20° C. to about 150° C. and a pressure of about 1 atmosphere (101 kPa) to about 100 atmospheres (10 MPa) to form an aldehyde-functionalized polysaccharide having pendant aldehyde groups; and
b) recovering the aldehyde-functionalized polysaccharide having pendant aldehyde groups.

### DETAILED DESCRIPTION

As used above and throughout the description of the invention, the following terms, unless otherwise indicated, shall be defined as follows:

The term “aldehyde-functionalized polysaccharide” refers to a polysaccharide that has been chemically modified to contain pendant aldehyde groups that are not produced by ring-cleavage oxidation.

The term “pendant aldehyde group” refers to an aldehyde-functional group that is attached to the ring of the polysaccharide via one of the ring hydroxyl groups.

The term “alkene-functionalized polysaccharide” refers to a polysaccharide that has been chemically modified to contain groups with C═C bond unsaturation (e.g., CH₃CH═CH—CH₂— or CH₃CH₂CH═CHCH₂— or CH₃CH═CH—O—) attached to the rings of the polysaccharide via the ring hydroxyl groups.

The term “allyl-functionalized polysaccharide” refers to a polysaccharide that has been chemically modified to contain allyl groups (i.e., CH₂═CH—CH₂—) attached to the ring of the polysaccharide via one of the ring hydroxyl groups.

The term “degree of substitution” of a functionalized polysaccharide, e.g. an allyl-functionalized polysaccharide, also referred to herein as “D.S.”, refers to the number of functional units, e.g. allyl units, per polysaccharide ring repeat unit.

The term “alkene-functionalized electrophilic compound” as used herein, refers to a chemical compound containing C═C bond unsaturation and additionally an electron-accepting group which is capable of forming a covalent bond with a nucleophile.

The term “allylic electrophilic compound” as used herein, refers to a chemical compound containing an allyl group (i.e., CH₂═CH—CH₂—) and an electron-accepting group which is capable of forming a covalent bond with a nucleophile.

The term “ether bond” refers to a chemical linkage of two substituted or unsubstituted alkyl or aryl groups through an oxygen atom, (i.e., R—O—R′).

The term “ester bond” refers to a chemical linkage of two substituted or unsubstituted alkyl or aryl groups through a carboxyl group

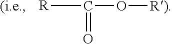

The term “carbonate bond” refers to a chemical linkage of two substituted or unsubstituted alkyl or aryl groups through a carbonate group

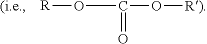

The term “urethane bond” refers to a chemical linkage of two substituted or unsubstituted alkyl or aryl groups through a carbamate group

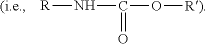

The term “water-dispersible, multi-arm polyether amine” refers to a polyether having three or more polymer chains (“arms”), which may be linear or branched, emanating from a central structure, which may be a single atom, a core molecule, or a polymer backbone, wherein at least three of the branches (“arms”) are terminated by a primary amine group. The water-dispersible, multi-arm polyether amine is water soluble or is able to be dispersed in water to form a colloidal suspension capable of reacting with a second reactant in aqueous solution or dispersion.

The term “polyether” refers to a polymer having the repeat unit [—O—R]—, wherein R is a hydrocarbylene group having 2 to 5 carbon atoms. The polyether may also be a random or block copolymer comprising different repeat units which contain different R groups.

The term “primary amine” refers to a neutral amino group having two free hydrogens. The amino group may be bound to a primary, secondary or tertiary carbon.

The term “crosslink” refers to a bond or chain of atoms attached between and linking two different polymer chains.

The term “% by weight”, also referred to herein as “wt %” refers to the weight percent relative to the total weight of the solution or dispersion, unless otherwise specified.

The term “anatomical site” refers to any external or internal part of the body of humans or animals.

The term “tissue” refers to any biological tissue, both living and dead, in humans or animals.

The term “hydrogel” refers to a water-swellable polymeric matrix, consisting of a three-dimensional network of macromolecules held together by covalent crosslinks that can absorb a substantial amount of water to form an elastic gel.

The term “PEG” as used herein refers to poly(ethylene glycol).

The term “M_{w}” as used herein refers to the weight-average molecular weight. The term “Mₙ” as used herein refers to the number-average molecular weight.

The term “medical application” refers to medical applications as related to humans and animals.

Disclosed herein is a novel method for making an aldehyde-functionalized polysaccharide having pendant aldehyde groups. The method comprises the hydroformylation of an alkene-functionalized polysaccharide, as described herein. The resulting aldehyde-functionalized polysaccharides may be reacted with various amine-containing polymers to form hydrogel tissue adhesives and sealants, which have desirable properties for medical applications.

In the method disclosed herein, the aldehyde-functionalized polysaccharide is made by reacting an alkene-functionalized polysaccharide with a mixture of carbon monoxide and hydrogen in the presence of a metal hydroformylation catalyst in a solvent. The reaction may be carried out at various conditions of temperature and pressure. Specifically, the reaction temperature is about 20° C. to about 150° C., more particularly, about 20° C. to about 100° C., and more particularly, about 20° C. to about 50° C. In one embodiment, the reaction temperature is about 20° C. In another embodiment, the reaction temperature is about 50° C. In another embodiment, the reaction temperature is about 80° C. The reaction pressure is about 1 atmosphere (101 kPa) to about 100 atmospheres (10 MPa), more particularly, about 1 atmosphere (101 kPa) to about 30 atmospheres (3.0 MPa), and more particularly, about 1 atmosphere (101 kPa) to about 10 atmospheres (1.0 MPa). In one embodiment, the reaction is carried out at a pressure of about 1 atmosphere (101 kPa). In another embodiment, the reaction is carried out at a pressure of about 27.2 atmospheres (2.76 MPa). In another embodiment, the reaction is carried out at a pressure of about 20.4 atmospheres (2.07 MPa).

Suitable solvents for use in the reaction include, but are not limited to, water, methanol, ethanol, propanol, dimethyl sulfoxide, N,N-dimethylformamide, and N,N-dimethyacetamide. In one embodiment the solvent is water. In another embodiment the solvent is methanol.

The mixture of carbon monoxide and hydrogen used in the reaction has a ratio of carbon monoxide to hydrogen of about 4:1 to about 1:4, more particularly, about 2:1 to about 1:2, and more particularly about 1:1 by volume.

The metal hydroformylation catalyst can be any metal hydroformylation catalyst known in the art, including but not limited to, rhodium complexes such as: Rh(CO)₂acetylacetonate, Rh(PPh₃)₂(CO)Cl, RhH(CO)(PPh₃)₃, Rh(CO)₃(Ph₃P)₂BPh₄, Rh(cyclooctadiene)(Ph₃P)₂BPh₄, [Rh(cyclooctadiene)(acetate)]₂, [Rh(cyclooctadiene)Cl]₂, and [Rh(cyclooctadiene)(trifluoroacetate)]₂, alone or in combination with phosphorus compounds such as: a triarylphosphine or a sulfonated triarylphosphine. In a preferred embodiment, the rhodium catalyst is used on combination with the phosphine catalyst. In some embodiments, the phosphorus compounds include, but are not limited to, diphenylphosphinobenzenesulfonate and triphenylphosphine. Suitable phosphorus:rhodium molar ratios for the catalyst range from 1 (equimolar P and Rh) to about 100 (100 times as much P as Rh), more particularly about 2 to about 50, and more particularly about 10 to about 30.

The aldehyde-functionalized polysaccharide having pendant aldehyde groups formed in the reaction can be recovered using methods known in the art, such as rotary evaporation, precipitation in a non-solvent for the product which is miscible with the reaction solvent and subsequent filtration, and lyophilization. The catalyst can be removed by various methods such as filtration, extraction into a second solvent after precipitation or evaporation, dialysis, or absorption on carbon.

Nonlimiting examples of alkene-functionalized polysaccharides that are useful in the method disclosed herein include alkene-functionalized derivatives of dextran, carboxymethyldextran, starch, agar, cellulose, hydroxyethylcellulose, carboxymethylcellulose, pullulan, inulin, levan, and hyaluronic acid. In one embodiment, the polysaccharide is dextran. The starting polysaccharides are available commercially from sources such as Sigma Chemical Co. (St. Louis, Mo.). Typically, polysaccharides are a heterogeneous mixture having a distribution of different molecular weights, and are characterized by an average molecular weight, for example, the weight-average molecular weight (M_{w}), or the number average molecular weight (Mₙ), as is known in the art. Therefore, the aldehyde-functionalized polysaccharides prepared from these polysaccharides are also a heterogeneous mixture having a distribution of different molecular weights. Suitable aldehyde-functionalized polysaccharides have a weight-average molecular weight of about 1,000 to about 1,000,000 Daltons, more particularly about 3,000 to about 250,000 Daltons, more particularly about 5,000 to about 60,000 Daltons, and more particularly about 7,000 to about 20,000 Daltons.

Alkene-functionalized polysaccharides may be prepared using various methods. For example, the alkene-functionalized polysaccharide can be made by reacting a polysaccharide, such as those listed above, with an alkene-functionalized electrophilic compound, capable of reacting with hydroxyl groups of the polysaccharide to form ether bonds, in the presence of a strong base in an anhydrous, polar aprotic solvent. The reaction is done at a temperature of about 20° C. to about 150° C., more particularly, about 20° C. to about 50° C., and more particularly about 45° C. In one embodiment, the alkene-functionalized polysaccharide is an allyl-functionalized polysaccharide.

Suitable alkene-functionalized electrophilic compounds, capable of reacting with hydroxyl groups of the polysaccharide to form ether bonds, include, but are not limited to, allyl chloride, allyl bromide, allyl iodide, allyl methanesulfonate, allyl toluenesulfonate, allyl glycidyl ether, 3-butenylchloride, 3-butenyl bromide, 3-butenyl iodide, 2-butenyl chloride, 2-butenyl bromide, 2-butenyl iodide, 4-pentenyl chloride, 4-pentenyl bromide, 4-pentenyl iodide, 3-pentenyl chloride, 3-pentenyl bromide, 3-pentenyl iodide, 2-pentenyl chloride, 2-pentenyl bromide, 2-pentenyl iodide, 2-methylallyl chloride, 2-methylallyl bromide, and 2-methylallyl iodide. In one embodiment, the alkene-functionalized electrophilic compound is allyl chloride.

Suitable anhydrous, polar aprotic solvents include, but are not limited to, dimethyl sulfoxide, N,N-dimethylformamide, N,N-dimethyacetamide, and N-methylpyrrolidone. If the solvent is an amide solvent such as N,N-dimethylformamide, N,N-dimethyacetamide, or N-methylpyrrolidone, a salt such as lithium chloride (for example at a concentration of about 2 wt %) may be added to increase the solubility of the polysaccharide.

Examples of useful strong bases include, but are not limited to, sodium hydroxide, potassium hydroxide, sodium hydride, potassium hydride, butyllithium, potassium t-butoxide, sodium t-butoxide, and lithium diisopropylamide.

The alkene-functionalized polysaccharide formed can be recovered using methods known in the art, such as dialysis, lyophilization, or precipitation into a non-solvent for the product in which the reaction solvent is soluble.

Additionally, the alkene-functionalized polysaccharide can be made by reacting a polysaccharide, such as those listed above, with an alkene-functionalized electrophilic compound, capable of reacting with hydroxyl groups of the polysaccharide to form ester, carbonate, or urethane bonds. The reaction is carried out in a solvent such as dimethyl sulfoxide, N,N-dimethylformamide, N,N-dimethyacetamide, or N-methylpyrrolidone at a temperature of about 20° C. to about 150° C., more particularly, about 20° C. to about 50° C., and more particularly about 50° C. If the solvent is an amide solvent such as N,N-dimethylformamide, N,N-dimethyacetamide, or N-methylpyrrolidone, a salt such as lithium chloride (for example at a concentration of about 2 wt %) may be added to increase the solubility of the polysaccharide.

The degree of substitution of the alkene-functionalized polysaccharide, or aldehyde-functionalized polysaccharide, is typically within the range of about 0.1 to about 3.0, including but not limited to from about 0.25 to about 3.0, from about 0.5 to about 2.5, from about 0.5 to about 2.0, from about 1.0 to about 2.0, and includes any combination of these range limits between about 0.1 and about 3.0.

Suitable alkene-functionalized electrophilic compounds, capable of reacting with hydroxyl groups of the polysaccharide to form ester, carbonate, or urethane bonds include, but are not limited to, allyl isocyanate, 3-butenoic acid activated with a carbodiimide, 3-pentenoic acid activated with a carbodiimide, 4-pentenoic acid activated with a carbodiimide, N-hydroxysuccinimidyl ester of 3-butenoic acid, N-hydroxysuccinimidyl ester of 3-pentenoic acid, N-hydroxysuccinimidyl ester of 4-pentenoic acid, and allyl chloroformate. In one embodiment, the alkene-functionalized electrophilic compound, capable of reacting with hydroxyl groups of the polysaccharide to form ester, carbonate, or urethane bonds, is allyl isocyanate.

Optionally, an organo-tin catalyst such as tin octoate, dibutyltin oxide, dibutyltin diacetate or dibutyltin dilaurate, alone or in combination with a tertiary amine such as diazobicyclooctane, may be used to accelerate the reaction of an isocyanate with the polysaccharide OH groups. Such a catalyst is typically used at a level of about 0.1 mol % to about 1 mol % relative to the isocyanate, and the tertiary amine, if used, being about 50 wt % to about 75 wt % of the catalyst mixture. A higher catalyst level gives a faster reaction. Tin octoate at 0.1 mol % catalyzes urethane formation at a rate 500 times or more than the uncatalyzed rate.

The alkene-functionalized polysaccharide formed can be recovered using methods known in the art, such as dialysis, lyophilization, or precipitation into a non-solvent for the product in which the reaction solvent is soluble.

The aldehyde-functionalized polysaccharides made by the method disclosed herein may be used in combination with various amine-containing polymers to prepare hydrogel tissue adhesives and sealants for medical and veterinary applications, including, but not limited to, wound closure, supplementing or replacing sutures or staples in internal surgical procedures such as intestinal anastomosis and vascular anastomosis, tissue repair, preventing leakage of fluids such as blood, bile, gastrointestinal fluid and cerebrospinal fluid, ophthalmic procedures, drug delivery, and preventing post-surgical adhesions. For example, an aldehyde-funtionalized polysaccharide may be used in place of an oxidized polysaccharide to react with a multi-arm polyether amine (Kodokian et al., copending and commonly owned U.S. Patent Application Publication No. 2006/0078536 A1). Alternatively, an aldehyde-funtionalized polysaccharide may be used in place of an oxidized polysaccharide to react with a polymer having amino groups such as chitosan or a modified polyvinyl alcohol having amino groups (Goldmann, U.S. Patent Application Publication No. 2005/000289 A1), or with an amino group containing polymer such as poly L-lysine (Nakajima et al., U.S. Patent Application Publication No. 2008/0319101 A1).

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations used is as follows: the designation “10K” means that a polymer molecule possesses a weight-average molecular weight of 10 kiloDaltons, a designation of “40K” indicates a weight-average molecular weight of 40 kiloDaltons, etc, “min” means minute(s), “hr” means hour(s), “sec” means second(s), “mL” means milliliter(s), “mol” means mole(s), “mmol” means millimole(s), “g” means gram(s), “mg” means milligram(s), “EW” means equivalent weight, “MW” means molecular weight, “wt %” means percent by weight, “mol %” means mole percent, “Vol” means volume, “v/v” means volume per volume, “PEG” means polyethylene glycol, “Da” means Daltons, “kDa” means kiloDaltons, “MWCO” means molecular weight cut-off, “Pa” means pascal(s), “kPa” means kilopascal(s), “MPa” means megapascal(s), “¹H NMR” means proton nuclear magnetic resonance spectroscopy, “ppm” means parts per million, “D” means density in g/mL, and “psig” means pounds per square inch gauge, and “rpm” means revolutions per minute.

A reference to “Aldrich” or a reference to “Sigma” means the said chemical or ingredient was obtained from Sigma-Aldrich, St. Louis, Mo. A reference to “NOF” means the said chemical or ingredient was obtained from NOF Corp, Tokyo, Japan. A reference to “TCI America” means the said chemical or ingredient was obtained from TCI America, Portland, Oreg.

### Reagent Preparation

### Preparation of Eight-Arm PEG 10K Octaamine (P8-10-1):

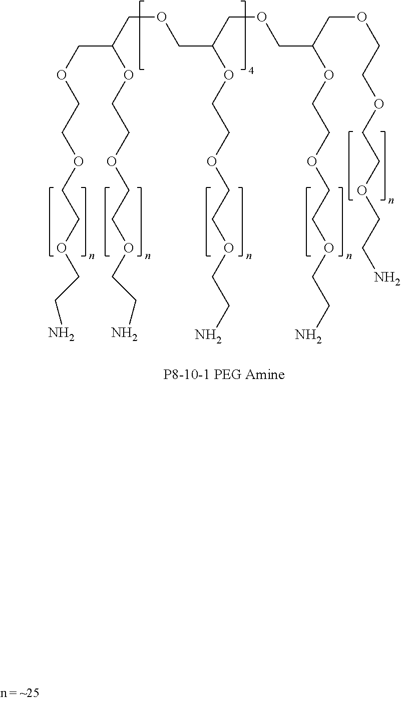

Eight-arm PEG 10K octaamine (Mₙ=10 kDa) was synthesized using the two-step procedure described by Chenault in U.S. Pat. No. 7,868,132. In the first step, an 8-arm PEG 10K chloride was made by reaction of thionyl chloride with an 8-arm PEG 10K octaalcohol. In the second step, the 8-arm PEG 10K chloride was reacted with aqueous ammonia to yield the 8-arm PEG 10K octaamine. A typical procedure is described here.

The 8-arm PEG 10K octaalcohol (Mₙ=10000, NOF SunBright HGEO-10000), (100 g in a 500-mL round-bottom flask) was dried either by heating with stirring at 85° C. under vacuum (0.06 mm of mercury (8.0 Pa)) for 4 hours or by azeotropic distillation with 50 g of toluene under reduced pressure (2 kPa) with a pot temperature of 60° C. The 8-arm PEG 10K octaalcohol was allowed to cool to room temperature and thionyl chloride (35 mL, 0.48 mol) was added to the flask, which was equipped with a reflux condenser, and the mixture was heated at 85° C. with stirring under a blanket of nitrogen for 24 hours. Excess thionyl chloride was removed by rotary evaporation (bath temp 40° C.). Two successive 50-mL portions of toluene were added and evaporated under reduced pressure (2 kPa, bath temperature 60° C.) to complete the removal of thionyl chloride. Proton NMR results from one synthesis are:

¹H NMR (500 MHz, DMSO-d6) δ 3.71−3.69 (m, 16H), 3.67−3.65 (m, 16H), 3.50 (s, ˜800H).

The 8-arm PEG 10K octachloride (100 g) was dissolved in 640 mL of concentrated aqueous ammonia (28 wt %) and heated in a pressure vessel at 60° C. for 48 hours. The solution was sparged for 1-2 hours with dry nitrogen to drive off 50 to 70 g of ammonia. The solution was then passed through a column (500 mL bed volume) of strongly basic anion exchange resin (Purolite® A-860, The Purolite Co., Bala-Cynwyd, Pa.) in the hydroxide form. The eluant was collected and three 250-mL portions of deionized water were passed through the column and also collected. The aqueous solutions were combined, concentrated under reduced pressure (2 kPa, bath temperature 60° C.) to about 200 g, frozen in portions and lyophilized to give the 8-arm PEG 10K octaamine, referred to to herein as P8-10-1, as a colorless waxy solid.

### Preparation of 8-Arm PEG 40K Hexadecaamine (P8-40-2):

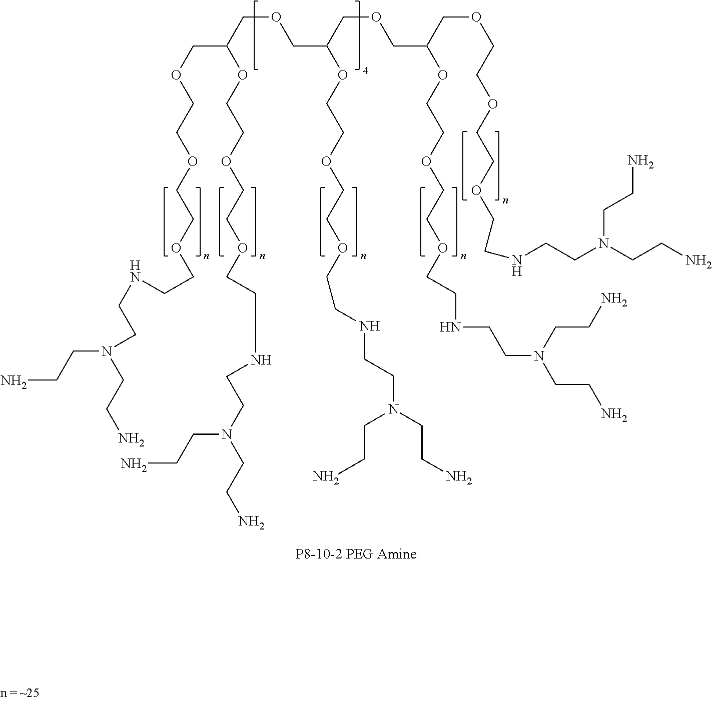

An 8-arm PEG 40K hexadecaamine, referred to herein as “P8-40-2”, having two primary amine groups at the end of the arms, was prepared using a two-step procedure, as described by Arthur in copending and commonly owned U.S. Patent Application Publication No. 2010/0086678 A1, in which 8-arm PEG 40K was reacted with thionyl chloride in toluene to produce 8-arm PEG 40K octachloride, which was subsequently reacted with tris(2-aminoethyl)amine to give the 8-arm PEG 40K hexadecaamine. A typical synthesis is described here.

A solution of 100 g (20 mmol OH) 8-arm PEG 40K (Mₙ=40,000; NOF SunBright HGEO-40000) in 200 mL toluene was heated to 70° C. and stirred under nitrogen as 6 mL thionyl chloride (10 g; 80 mmol) was quickly added. The mixture was stirred at 60° C. under nitrogen for 20 hr. After 20 hr the solution was bubbled with nitrogen for 1 hr while still warm to remove thionyl chloride and then 2 mL (50 mmol) methanol was added to scavenge remaining thionyl chloride. The solution added with stirring to 300 mL hexane to initially make a gelatinous precipitate which soon became friable and powdery as the toluene extracted from the product. The white suspension was stirred for an hour and then suction-filtered, washed once with 100 mL of hexane and suctioned dry under a nitrogen blanket to yield 99.0 g of 8-arm PEG 40K chloride.

A solution of 30.0 g (6.0 mmol Cl) 8-arm star PEG 40K chloride in 60 mL of water was rapidly stirred as 36 mL (35.3 g; 240 mmol) tris(2-aminoethyl)amine (TCI America #T1243) was added. The resulting solution was stirred in a 100° C. oil bath under nitrogen for 25 hr. Then, 0.5 mL (9 mmol) 50% sodium hydroxide was added and the mixture was cooled and extracted with 150 mL of dichloromethane followed by 2×100 mL dichloromethane. Separation was somewhat slow but eventually complete overnight. The combined extracts were dried with sodium sulfate, rotary evaporated to 120 mL and precipitated into 850 mL of ether with stirring. The ether was then stirred in an ice bath and the resulting white precipitate was suction-filtered under nitrogen, washed with 100 mL of diethyl ether and dried under nitrogen to yield 27.7 g (92%) 8-arm star PEG 40K hexadecaamine, referred to herein as P8-40-2, as a white powder.

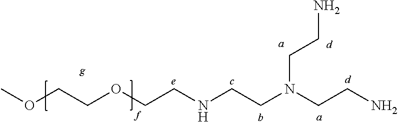

¹H NMR (CDCl₃): δ 2.53 ppm (t, J=6.0 Hz, a); 2.60 (t, J=6.1 Hz, b); 2.71 (t, J=6.1 Hz, c); 2.76 (t, J=5.9 Hz, d); 2.80 (t, J=5.2 Hz, e); 3.59 (t, J=5.3 Hz, f); 3.64 (s, g); 3.76 CH2Cl (t, J=6.0 Hz; h; gone). Integrate groups of peaks: 2.5-2.8 ppm (a-e; 14.3H; theory 14H); 3.5-3.8 ppm (f-g, PEG backbone, 500H). There was no remaining tris(2-aminoethyl)amine by NMR.

### Example 1

### Preparation of Dextran Having Pendant Aldehyde Groups by Hydroformylation of Allyl-Functionalized Dextran

Dextran having pendant aldehyde groups was prepared by hydroformylation of allyl-functionalized dextran in water at room temperature and 1 atmosphere (101 kPa).

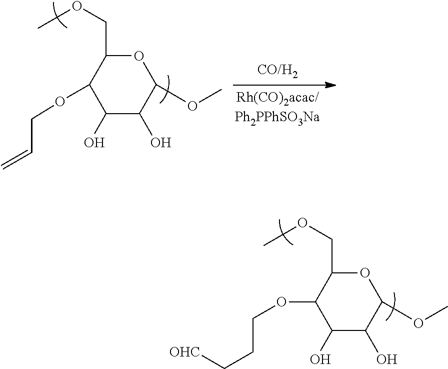

### Preparation of Allyl-Functionalized Dextran (EW=201, D.S.=1.05)

Dextran (5 g; 31 mmol; EW=162; M_{w}=10 kDa; Sigma D9260) was stirred in 72 mL of anhydrous dimethyl sulfoxide under nitrogen in a 250-mL, 3-neck flask for 15 min to form a slightly cloudy solution. To this was added 4.59 g (60 mmol; MW=76.5; Aldrich 236306) of allyl chloride followed by 7.2 g (180 mmol; MW=40) of powdered sodium hydroxide. After 20 min, solids started to precipitate. The reaction was stirred at room temperature for 45 min, followed by heating at 45° C. for 1 hr. The reaction solution was cooled to room temperature and added to 800 mL of water to give a clear solution. The solution pH was adjusted to 7.0 using dilute HCl solution and the solution was refrigerated overnight. The solution was clarified by filtration and purified using a Millipore filtration unit, with a 1000 MWCO minicassette. The solution was lyophilized to give allyl-functionalized dextran. From the NMR (D₂O) integral ratio of the peak at 6 ppm (central allyl proton) to the sum of the two peaks at 4.95 and 5.10 ppm (dextran anomeric proton), the product had a degree of substitution (D.S.) of 1.05=1.05 allyl units per dextran ring repeat unit.

### Hydroformylation of Allyl-Functionalized Dextran

Allyl-functionalized dextran (0.50 g; 2.5 mmol; EW=201; D.S.=1.05) was dissolved in 50 mL of deionized water at room temperature. The colorless hazy solution was syringe filtered and the filtrate was combined with 20 mg of rhodium dicarbonyl acetoacetate (0.078 mmol; MW=258.04; Aldrich 288101) and 50 mg of diphenylphosphinobenzenesulfonate sodium salt (0.137 mmol; MW=364; P:Rh=1.8, Aldrich 43151). This yellow solution of allyl dextran and rhodium catalyst was placed in a 250-mL flask with a frilled dip tube and magnetic stirrer. A 1:1 v/v carbon monoxide/hydrogen gas mixture was bubbled through the solution at 150 cm³/min with stirring for 20 hr. The mixture was initially very foamy and the rhodium salt appeared to be undissolved. Consequently, 20 mL of methanol was added and the foam abated somewhat. The resulting orange solution was filtered and then rotary evaporated using a hot water bath at 80° C. to yield dextran having pendant aldehyde groups.

By ¹H NMR (D₂O), the allyl protons (5.3 and 6.0 ppm) were completely gone, indicating hydroformylation had succeeded, and there were new peaks between 1-2 ppm due to the butyraldehyde side chain methylenes. However, brown solids were present in the product that were water-insoluble, indicating that the dextran aldehyde had crosslinked to during rotary evaporation in the hot water bath.

### Example 2

### Preparation of Dextran Having Pendant Aldehyde Groups by Hydroformylation of Allyl-Functionalized Dextran

Dextran having pendant aldehyde groups was prepared by hydroformylation of allyl-functionalized dextran in water at 50° C. and 400 psig (2.76 MPa).

### Preparation of Allyl-Functionalized Dextran (EW=265, D.S.=0.72)

Dextran (30 g; 185 mmol; EW=162; M_{w}=10 kDa; Sigma D9260) was dried at 80° C. for 2 days. This dry dextran was stirred in 432 mL of anhydrous dimethyl sulfoxide under nitrogen in a 500-mL, 3-neck flask for 30 min to form a clear solution. To this was added 17 g (222 mmol; mw=76.5; Aldrich 236306) of allyl chloride followed by 43.2 g (1.08 mol; MW=40.0) of powdered sodium hydroxide. After 20 min, solids started to precipitate. The reaction was stirred at room temperature for 25 min, followed by stirring and heating at 45° C. for 5.5 hr and finally stirring at room temperature overnight. The reaction solution was cooled to room temperature and added to 1300 mL of water to give a clear solution. The solution pH was adjusted to 7.0 using dilute HCl solution and the solution was clarified by filtration, and then was purified using a Millipore filtration unit, with a 1000 MWCO minicassette. The solution was lyophilized to give allyl-functionalize dextran. From the NMR (D₂O) integral ratio of the peak at 6 ppm (central allyl proton) to the sum of the two peaks at 4.95 and 5.10 ppm (dextran anomeric proton), the product had a degree of substitution of 0.72.

### Hydroformylation of Allyl-Functionalized Dextran

Allyl-functionalized dextran (3.0 g; 11.3 mmol allyl; EW=265; D.S.=0.72) was dissolved in 50 mL of deionized water. The resulting aqueous solution was combined with 10.5 mg of rhodium dicarbonyl acetoacetate (0.041 mmol; MW=258.04) and 60 mg of diphenylphosphinobenzenesulfonate sodium salt (0.165 mmol; MW=364; P:Rh=4.0). This solution of allyl dextran and rhodium catalyst was placed in a 600-mL stirred Parr autoclave (Parr Instrument Co., St. Moline, Ill.) and pressurized to 400 psig (2.76 MPa) with a 1:1 v/v mixture of carbon monoxide/hydrogen at 25° C. The mixture was heated to 50° C. and stirred at 100 rpm for 16 hr as the pressure fell to 235 psig (1.62 MPa) at 50° C. The autoclave was cooled and vented and a 1-mL sample of the reaction mixture was rotary evaporated from warm water (<50° C.) and then held under a nitrogen stream to yield dextran having pendant aldehyde groups.

By ¹H NMR (D₂O), the allyl protons at 5.3 and 6.0 ppm were completely gone, indicating hydroformylation had succeeded. There were also new peaks at 0.8-2.0 ppm reflecting formation of the butyral side chain; the higher-field peaks at 1.0-0.8 ppm are terminal methyls indicating that some reduction of the allyl groups also occurred. Solids were present that were mostly water-insoluble, indicating that the dextran aldehyde had crosslinked during isolation.

The remainder of the reaction mixture was frozen in liquid nitrogen and lyophilized to yield 2.87 g of dextran having pendant aldehyde groups. The resulting tan, fluffy solid dissolved readily in water at room temperature.

### Example 3

### Crosslinking Dextran Aldehyde Having Pendant Aldehyde Groups with a Multi-Arm PEG Amine

The purpose of this Example was to demonstrate the formation of a crosslinked hydrogel by reacting the dextran having pendant aldehyde groups, prepared as described in Example 2, with a multi-arm PEG amine.

A 20 wt % aqueous solution (0.25 mL) of the dextran having pendant aldehyde groups, prepared as described in Example 2, was combined with a 30 wt % aqueous solution (0.25 mL) of an 8-arm branched polyethyleneglycol amine (P8-40-2, MW=40 kDa) with two amines on each arm end. A crosslinked hydrogel was formed in a few seconds.

### Example 4

### Preparation of Dextran Having Pendant Aldehyde Groups by Hydroformylation of Allyl-Functionalized Dextran

Dextran having pendant aldehyde groups was prepared by hydroformylation of allyl-functionalized dextran in methanol at 80° C. and 400 psig (2.76 MPa).

Allyl-functionalized Dextran (EW=201, D.S.=1.05) was prepared as described in Example 1.

### Hydroformylation of Allyl-Functionalized Dextran

Allyl-functionalized dextran (0.6 g; 3 mmol; EW=201; D.S.=1.05) was dissolved in 25 mL of methanol at room temperature and filtered to remove haze. The clear filtrate was combined with 9.8 mg of rhodium dicarbonyl acetoacetate (0.038 mmol; MW=258.04) and 53 mg of diphenylphosphinobenzenesulfonate sodium salt (0.146 mmol; MW=364; P:Rh=3.8). This yellow solution of allyl dextran and rhodium catalyst was placed in a 600-mL stirred Parr autoclave and pressurized to 407 psig (2.81 MPa) with 1:1 v/v carbon monoxide/hydrogen at 25° C. The mixture was heated to 80° C. and stirred at 100 rpm for 15 hr. The resulting clear orange solution was decanted from a small amount of dark solids and rotary evaporated to yield 0.59 g of dextran having pendant aldehyde groups.

By ¹H NMR (D₂O), the allyl protons (5.3, 6.0 ppm) were completely gone, indicating hydroformylation had succeeded, and there were new peaks between 1-2 ppm due to the butyraldehyde side chain methylenes as well as terminal methyl from reduction. Brown solids were present that were water-insoluble, indicating that the dextran aldehyde had crosslinked during isolation.

### Example 5

### Preparation of Dextran Having Pendant Aldehyde Groups by Hydroformylation of Allylurethane Dextran

Dextran having pendant aldehyde groups was prepared by hydroformylation of allylurethane dextran in water at 50° C. and 300 psig (2.07 MPa).

### Preparation of Allylurethane Dextran (EW=265, D.S.=0.72)

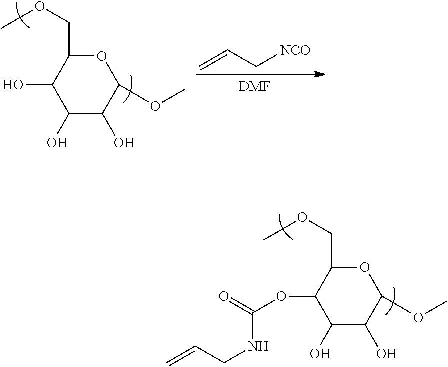

Dextran (MW=9-11 kDa; repeat unit MW=162; Sigma D9260) was vacuum-oven dried for 4 hr at 80° C. with a nitrogen sweep. A mixture of 10.0 g dextran (62 mmol repeat units) and 3 g of dry lithium chloride in 60 mL of anhydrous N,N-dimethylformamide in a 250-mL round bottom flask was magnetically stirred under nitrogen in an 80° C. oil bath for 30 min to give a clear solution. The bath was cooled to 50° C. and the solution was stirred as 7 mL of allyl isocyanate (6.6 g; 79 mmol; 1.27 eq based on repeat units; MW=83.09; D=0.94; Aldrich 243272) was added using a syringe. Then, 10 drops of dibutyltin diacetate (Aldrich 290890) was added as a catalyst and the clear solution was stirred at 50° C. under nitrogen for 22 hr.

The solution was cooled to room temperature and diluted with 300 mL of ether to precipitate the allylated dextran. The solvent was decanted and the dextran was washed once with 300 mL of fresh ether and decanted again. The gummy product was dissolved in 300 mL of water to give a milky, foamy solution. The solution pH was adjusted from 5 to 7 with sodium carbonate and the solution was filtered through coarse filter paper. The resulting aqueous filtrate was clarified by filtration through Celite® diatomaceous earth (World Minerals, Lompoc, Calif.) and was then dialyzed against 2000 mL of deionized water in a Millipore filtration unit, with a 1000 MWCO minicassette to remove salt and solvent. The resulting solution was lyophilized with no further clarification to yield 6.9 g of white, fluffy allyl urethane dextran.

¹H NMR in D₂O indicated a substitution level of 1.19 allylurethane units per dextran ring repeat unit by ratio of the secondary vinyl proton (5.9 ppm) integral to the total integral. There are 11 CH protons and 1 NH proton; the OH's don't show up in D₂O, having exchanged to become OD's. Therefore one proton=1/11=8.33% of the total; the integral for the secondary allyl proton is 9.88%, so the D.S. is 9.88/8.33=1.19.

### Hydroformylation of Allylurethane Dextran

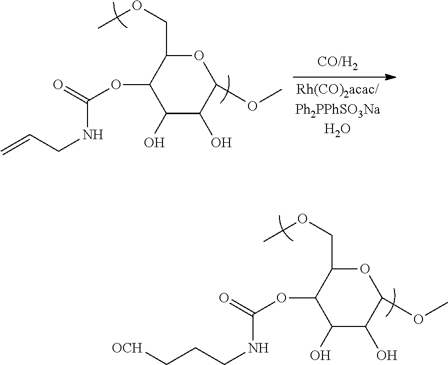

Allylurethane dextran (3.0 g) was dissolved in 50 mL of deionized water and combined with 10 mg of rhodium dicarbonyl acetoacetate (0.04 mmol; MW=258.04) and 60 mg of diphenylphosphinobenzenesulfonate sodium salt (0.165 mmol; MW=364; P:Rh=4.1). This solution of allylurethane dextran and rhodium catalyst was placed in a 600-mL stirred Parr autoclave and pressurized to 315 psig (2.17 MPa) with 1:1 v/v carbon monoxide/hydrogen at 25° C. The resulting mixture was heated to 50° C. and stirred for 16 hr as the pressure fell to 309 psig (2.13 MPa) at 50° C.

A 1-mL sample of the reaction mixture was evaporated under a nitrogen stream for analysis by NMR. The ¹H NMR (D₂O) indicated that the allyl vinyl protons (5-6 ppm) were completely gone, indicating hydroformylation had succeeded. The remainder of the solution was filtered through a mixture of Celite® diatomaceous earth and alumina in an attempt to remove the catalyst. The resulting solution still had some haze, and was lyophilized to yield 2.73 g of tan, fluffy dextran having pendant aldehyde groups.

A clear, tan 20 wt % aqueous solution could be made by magnetically stirring 0.130 g of the dextran having pendant aldehyde groups and 0.52 g of water at room temperature overnight. The resulting solution was somewhat foamy. This solution was reacted with hydroxylamine hydrochloride and titrated for CHO content with NaOH to give a CHO EW=522. Another solution of the dextran aldehyde was made by stirring for about one hour at room temperature and was also titrated to give EW=490. These values are much higher than expected (EW=250) based on the level of substitution. By NMR, the allyl olefinic protons (5.2 and 5.9 ppm) are all gone. However, it appears that some hydrogenation had occurred in competition with the hydroformylation reaction, reflected by a new peak at 0.95 ppm, which is a propyl terminal methyl resulting from allyl hydrogenation rather than hydroformylation. This average EW=510 corresponds to 54% hydroformylation and 46% reduction.

### Example 6

### Preparation of Dextran Having Pendant Aldehyde Groups by Hydroformylation of Allylurethane Dextran

Dextran having pendant aldehyde groups was prepared by hydroformylation of allylurethane dextran in methanol at 50° C. and 300 psig (2.07 MPa).

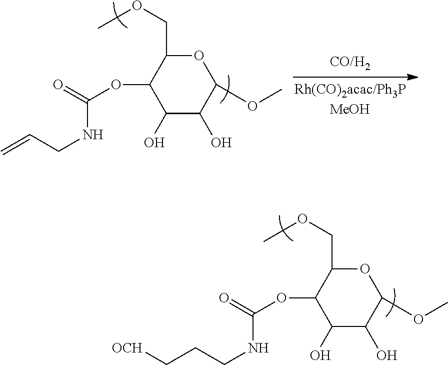

Allylurethane dextran (4.0 g), prepared as described in Example 5, was dissolved in 60 mL of methanol to give a clear solution which was filtered to remove a small amount of haze and was combined with 10.6 mg of rhodium dicarbonyl acetoacetate (0.041 mmol; MW=258.04) and 201 mg of triphenylphosphine (0.77 mmol; MW=262.3; P:Rh=19). This yellow solution of allylurethane dextran and rhodium catalyst was placed in a 600-mL stirred Parr autoclave, which was pressurized to 315 psig (2.17 MPa) with a 1:1 v/v (volume=molar) carbon monoxide/hydrogen at 23° C. The resulting mixture was stirred and heated at 50° C. for 20 hr as the pressure fell from 346 at 50° C. to 326 psig, after which the reaction mixture was cooled and vented.

A 3-mL sample of the resulting clear yellow solution was evaporated under a nitrogen stream to yield a white solid. Upon stirring with 1 mL of D₂O, the white solid dispersed to form a milky white suspension. The suspension was filtered through a 5-μm syringe filter to give a pale yellow hazy solution. By ¹H NMR (D₂O), the allyl protons were completely gone, indicating hydroformylation had succeeded. The allyl protons had been replaced by CH₂ peaks around 2 ppm and an aldehyde peak at 9.65 ppm. However, there were also methyl triplets at 0.94 and 1.11 ppm, indicating some reduction of the allyl group to a propyl group.

The remainder of the clear yellow solution was filtered through a coarse frit to remove a small amount of fine particulates. The clear yellow filtrate was stirred with 150 mL of diethyl ether to precipitate the dextran aldehyde as a white gum. The ether was decanted and the gum was stirred with 100 mL of fresh ether, during which time the product became hard and was broken up into a white powder. Suction filtration and drying under nitrogen overnight yielded 4.28 g of white powder.

The NMR (D₂O) spectrum exhibited a peak for an aldehyde proton at 9.64 ppm and propyl methyl peaks at 0.95 and 1.12 ppm resulting from allyl reduction, as well as peaks at 1.18 and 3.56 ppm due to diethyl ether, which accounts for the high yield weight; the allyl vinyl protons were gone. The product was reacted with hydroxylamine hydrochloride and titrated with NaOH for CHO content to give an average CHO EW=339. This EW value is somewhat higher than expected (EW=250) based on the level of allyl substitution and corresponds to 85% of the allyls having been hydroformylated and 15% reduced. While some hydrogenation occurred in competition with the hydroformylation reaction, the degree of hydrogenation was considerably less in this case than in Example 5, where much less phosphine co-catalyst was used (P:Rh˜4).

### Example 7

### Crosslinking Dextran Aldehyde Having Pendant Aldehyde Groups with a Multi-Arm PEG Amine

The purpose of this Example was to demonstrate the formation of a crosslinked hydrogel by reacting the dextran having pendant aldehyde groups, prepared in Example 6, with a multi-arm PEG amine.

A 20 wt % aqueous solution (0.25 mL) of the hydroformylated allylurethane dextran of Example 6 was combined and stirred with an equal volume of a 35 wt % aqueous solution of P8-10-1 PEG amine (8-arm polyethylene glycol star; M_{w}=10 kDa; 8 NH₂ groups; CHO:NH₂=2.1) on a glass microscope slide. The mixture quickly gelled in about 5 seconds to give a clear, flexible hydrogel.

What is claimed is:

1. A method for making an aldehyde-functionalized polysaccharide having pendant aldehyde groups, said method comprising the steps of:
a) reacting in a solvent, an alkene-functionalized polysaccharide with a mixture of carbon monoxide and hydrogen, said mixture having a ratio of carbon monoxide to hydrogen of about 4:1 to about 1:4 by volume, in the presence of a metal hydroformylation catalyst at a temperature of about 20° C. to about 150° C. and a pressure of about 1 atmosphere (101 kPa) to about 100 atmospheres (10 MPa) to form an aldehyde-functionalized polysaccharide having pendant aldehyde groups; and
b) recovering the aldehyde-functionalized polysaccharide having pendant aldehyde groups.

2. The method of claim 1, wherein the alkene-functionalized polysaccharide is made by a method comprising the steps of:
a) reacting in an anhydrous, polar aprotic solvent, a polysaccharide with an alkene-functionalized electrophilic compound, capable of reacting with hydroxyl groups of the polysaccharide to form ether bonds, in the presence of a strong base at a temperature of about 20° C. to about 150° C. to form an alkene-functionalized polysaccharide; and
b) recovering the alkene-functionalized polysaccharide.

3. The method of claim 2, wherein the alkene-functionalized electrophilic compound is selected from the group consisting of: allyl chloride, allyl bromide, allyl iodide, allyl methanesulfonate, allyl toluenesulfonate, allyl glycidyl ether, 3-butenyl chloride, 3-butenyl bromide, 3-butenyl iodide, 2-butenyl chloride, 2-butenyl bromide, 2-butenyl iodide, 4-pentenyl chloride, 4-pentenyl bromide, 4-pentenyl iodide. 3-pentenyl chloride, 3-pentenyl bromide, 3-pentenyl iodide, 2-pentenyl chloride, 2-pentenyl bromide, 2-pentenyl iodide. 2-methylallyl chloride, 2-methylallyl bromide, and 2-methylallyl iodide.

4. The method of claim 3, wherein the alkene-functionalized electrophilic compound is allyl chloride.

5. The method of claim 2, wherein the polysaccharide is selected from the group consisting of: dextran, carboxymethyldextran, starch, agar, cellulose, hydroxyethylcellulose, carboxymethylcellulose, pullulan, inulin, levan, and hyaluronic acid.

6. The method of claim 5, wherein the polysaccharide is dextran.

7. The method of claim 2, wherein the strong base is selected from the group consisting of: sodium hydroxide, potassium hydroxide, sodium hydride, potassium hydride, butyllithium, potassium t-butoxide, sodium t-butoxide, and lithium diisopropylamide.

8. The method of claim 2, wherein the anhydrous, polar aprotic solvent is selected from the group consisting of dimethyl sulfoxide, N,N-dimethylformamide, N,N-dimethyacetamide, and N-methylpyrrolidone.

9. The method of claim 1, wherein the alkene-functionalized polysaccharide is made by a method comprising the steps of:
a) reacting in a solvent, a polysaccharide with an electrophilic alkene-functional compound, capable of reacting with hydroxyl groups of the polysaccharide to form ester, carbonate, or urethane bonds, at a temperature of about 20° C. to about 150° C. to form an alkene-functionalized polysaccharide;
b) recovering the alkene-functionalized polysaccharide.

10. The method of claim 9, wherein the alkene-functionalized electrophilic compound is selected from the group consisting of: allyl isocyanate, 3-butenoic acid activated with a carbodiimide, 3-pentenoic acid activated with a carbodiimide, 4-pentenoic acid activated with a carbodiimide, N-hydroxysuccinimidyl ester of 3-butenoic acid, N-hydroxysuccinimidyl ester of 3-pentenoic acid, N-hydroxysuccinimidyl ester of 4-pentenoic acid, and allyl chloroformate,

11. The method of claim 10, wherein the alkene-functionalized electrophilic compound is allyl isocyanate.

12. The method of claim 9, wherein the polysaccharide is selected from the group consisting of: dextran, carboxymethyldextran, starch, agar, cellulose, hydroxyethylcellulose, carboxymethylcellulose, pullulan, inulin, levan, and hyaluronic acid.

13. The method of claim 12, wherein the polysaccharide is dextran.

14. The method of claim 9, wherein the solvent is selected from the group consisting of: dimethyl sulfoxide, N,N-dimethylformamide, N,N-dimethyacetamide, and N-methylpyrrolidone.

15. The method of claim 1, wherein the metal hydroformylation catalyst is a rhodium complex in combination with a phosphorus compound.

16. The method of claim 1, wherein the metal hydroformylation catalyst is a rhodium complex selected from the group consisting of: Rh(CO)₂acetylacetonate, Rh(PPh₃)₂(CO)Cl, RhH(CO)(PPh₃)₃, Rh(CO)₃(Ph₃P)₂BPh₄, Rh(cyclooctadiene)(Ph₃P)₂BPh₄, [Rh(cyclooctadiene)(acetate)]₂, [Rh(cyclooctadiene)Cl]₂, and [Rh(cyclooctadiene)(trifluoroacetate)]₂, in combination with a triarylphosphine or a sulfonated triarylphosphine.

17. The method of claim 1, wherein the solvent is selected from the group consisting of: water, methanol, ethanol, propanol, dimethyl sulfoxide, N,N-dimethylformamide, and N,N-dimethyacetamide.

18. The method of claim 1, wherein the aldehyde-functionalized polysaccharide comprises:
(i) a polysaccharide selected from the group consisting of dextran, carboxymethyldextran, starch, agar, cellulose, hydroxyethylcellulose, carboxymethylcellulose, pullulan, inulin, levan, and hyaluronic acid; and
(ii) an aldehyde functional group selected from the group consisting of allyl, butenyl, pentenyl, and methylallyl.

19. The method of claim 18, wherein aldehyde functional group is selected from the group consisting of allyl, 3-butenyl, 2-butenyl, 4-pentenyl, 3-pentenyl, 2-pentenyl, 2-pentenyl, and 2-methylallyl.

20. A method for making an aldehyde-functionalized polysaccharide having pendant aldehyde groups, said method comprising the steps of:
a) reacting in an anhydrous, polar aprotic solvent, a polysaccharide with an alkene-functionalized electrophilic compound, capable of reacting with hydroxyl groups of the polysaccharide to form ether, ester, carbonate or urethane bonds, to form an alkene-functionalized polysaccharide;
b) recovering the alkene-functionalized polysaccharide,
c) reacting in a solvent, the alkene-functionalized polysaccharide with a mixture of carbon monoxide and hydrogen, said mixture having a ratio of carbon monoxide to hydrogen of about 4:1 to about 1:4 by volume, in the presence of a metal hydroformylation catalyst to form an aldehyde-functionalized polysaccharide having pendant aldehyde groups; and
d) recovering the aldehyde-functionalized polysaccharide having pendant aldehyde groups.
